(19) United States
(12) Patent Application Publication
(10) Pub. No.: US 2025/0303341 A1
(43) Pub. Date: Oct. 2, 2025

(54) METHOD AND APPARATUS FOR TREATMENT OF PROCESS GAS

(71) Applicant: Dürr Systems AG, Bietigheim-Bissingen (DE)

(72) Inventors: Jens ALTMANN, Freiberg (DE); Houver CHABO, Heilbronn (DE); Jeffrey C. RUDOLPH, Suamico, WI (US)

(21) Appl. No.: 18/861,823

(22) PCT Filed: May 22, 2023
(86) PCT No.: PCT/DE2023/000035

§ 371 Date: Oct. 30, 2024

(30) Foreign Application Priority Data
May 24, 2022 (DE) 10 2022 113 075.4

(51) Int. Cl. B01D 53/00; B01D 46/00; B01D 53/04; H01M 4/04

(52) U.S. Cl. CPC B01D 53/002; B01D 46/0036; B01D 53/0446; B01D 2259/40086; B01D 2259/45; H01M 4/04

(57) ABSTRACT

A method of treatment of process gas from an industrial process having a main stream and a secondary stream, wherein at least a portion of the process gas is treated by the following process steps: a first condensation step, in which a first condensate is separated out of the process gas; a first branching that takes place after the first condensation step, in which at least a portion of the process gas is branched off from the main stream as offgas into the secondary stream; a first further treatment step that takes place in the main stream after the first branching, in which at least a portion of the process gas is treated further after the first condensation step.

### TECHNICAL FIELD

The present disclosure relates to a method of treatment of process gas from an industrial process.

### BACKGROUND

Process gas can be used as a medium in certain process steps for production of products, in order to bring about certain technical effects such as drying in a process step. As used herein, a process gas means a gas or gas mixture that serves to have a technical effect on the product to be produced. Depending on the product and industrial process, the process gas may be an inert or non-inert gas or gas mixture. Especially in the case of non-inert process gas, air or air-like gas mixtures are frequently used. In that case, the term “process air” is frequently also used synonymously for process gas. The process gas can take up in industrial processes, where the process gas is released into the environment after leaving the industrial process. However, such operating media can contain pollutants or solvents that have an adverse effect on the environment. In order to reduce the adverse effect on the environment, this offgas must be treated appropriately, also in order to comply with given legal limits in the offgas to be released into the environment. If the process gas is a process air, the offgas is frequently also referred to synonymously as waste air. A main distinction feature between an offgas and waste air may especially be an O₂ concentration in the underlying gas mixture. Pollutants or pollutant-containing solvents especially mean substances which, in a certain amount or concentration in the gas output, can damage plants, animals and/or humans in the environment. The pollutants may, for example, be solvents (e.g. NMP, NEP, TEP, EAA, GBL, etc.), hydrocarbons, nitrogen oxides, ammonia, hydrogen fluoride, etc.

Conventional apparatuses for treatment of process gas frequently contain a main stream channel through which a process gas stream is directed. The main stream channel is typically arranged between an outlet for discharge of process gas to be cleaned from the industrial process and an inlet for introduction thereof into a condenser; in particular, it connects the outlet to the inlet. The pollutants or solvents present in the process gas can condense in the condenser, and the condensed pollutants or solvents are thus preferably separated at least partly from the process gas. A portion of the treaty process gas is frequently branched off from the main stream as offgas to an offgas outlet into the environment.

The prior art especially discloses methods having a condensation step, wherein condensates can be separated out of the process gas and solvents recovered thereby.

CA2214542A1 discloses a process in which a solvent in the production of lithium ion batteries can be recovered by condensing the solvent out of a solvent-containing process air.

### SUMMARY

Examples disclosed herein relate to a method of treating process gas, especially for recovering solvents that are used in industrial processes, as in the production of lithium ion batteries. The method comprises condensation operations that work at different temperature levels, where a solvent-containing condensate is separated out of the process gas and then fed to a recovery process. Examples disclosed herein likewise relate to an apparatus for treatment of process gas from an industrial process, especially for execution of a method of the invention.

It is an object of examples disclosed herein to provide an improved method of treating process gas from an industrial plant/an industrial process, which results in elevated use flexibility with avoidance of extreme operating costs and excessively complex constructions, coupled with a strong cleaning effect on the process gas.

This object is achieved in accordance with examples disclosed herein by a method of treating process gas from an industrial process having a main stream and a secondary stream, wherein at least a portion of the process gas is treated by the following method steps: a first condensation step in which a first condensate is separated out of the process gas; a first branching operation which takes place after the first condensation step and in which at least a portion of the process gas is branched off from the main stream into the secondary stream as offgas; a first further treatment step which takes place after the first branching operation in the main stream and in which at least a portion of the process gas is subjected to further treatment after the first condensation step. Examples disclosed herein may advantageously be used both for treatment, especially for processing or cleaning, of process gas and of process air, such that, in the context of examples disclosed herein, the terms “process gas” and “process air” or “offgas” and “waste air” should be considered to be synonymous.

The first further treatment step may also comprise supply of heat, lowering of pressure and/or a second feed of ambient air or process gas from outside the main stream, for example from a secondary stream. More preferably, in the first further treatment step, heat is supplied, where the thermal energy has been obtained from the first condensation step. The supply of heat in the first further treatment step can thus be regarded as a recovery of heat. An offgas in the context of examples disclosed herein may especially be a process gas removed from the main stream or from a main stream channel. The offgas may be removed, for example, to the environment, but also passed onward into an industrial process and/or to at least one further process step for further treatment.

This is because the inventors have found that it can be advantageous for the treatment of process gas first to treat a portion of the process gas in a first condensation step and then to branch it off into a secondary stream channel. The remainder of the process gas is subjected to further treatment in a further treatment step. The first condensation step can be effected in a more energetically favorable range, and it is possible to use a heat transfer medium for cooling of the process gas, which is cooled down in a less energy-demanding manner. The treatment in a first condensation step can promote solvent recovery and at the same time lower the pollutant concentration of the offgas.

The volume flow branched off into the secondary stream in the first branching operation is typically smaller than the volume flow present in the main stream after the first branching operation. The process gas is preferably divided into at least two streams after the first condensation step, for example into a main stream and a secondary stream. Even in the case of branching into multiple secondary streams, the volume flow branched off overall, added up over all the secondary streams, is preferably smaller than the volume flow present that remains in the main stream downstream of the first branching operation.

“A” in the context of this disclosure, without any statement to the contrary, shall be read as the indefinite article and hence always also as “at least one”; it is thus possible to provide multiple second condensation steps after multiple first condensation steps. The first or second condensation step may in each case also be regarded as a multistage first or multistage second condensation step. In particular, a first or second condensation step may comprise multiple condensation operations (see below). A condensation stage may have, for example, a heat exchanger or heat sink through which the process gas is directed. In particular, two or more condensation stages may be connected in series. For example, two or more different heat exchangers or heat sinks may be arranged in succession, which cool the process gas down to different temperature levels. A condensation step may thus comprise a multistage cooling operation.

Statements of direction such as “upstream” or “downstream” in the method relate generally to flow direction. For example, the wording “downstream of the first condensation step” and “upstream of the second condensation step” shall be understood to mean “downstream of the first condensation step in flow direction” and “upstream of the second condensation step in flow direction”. A heat transfer medium may especially be a cooling medium or else a coolant. For example, the heat transfer medium may comprise water, ammonia, carbon dioxide, organic coolants or inorganic coolants.

A heat transfer medium may be used in a cooling stage for cooling of the process gas in a condensation step, where heat is withdrawn from the process gas in a displacement of heat in the cooling stage and is transported away by means of the heat transfer medium. The displacement of heat may be considered to be a transfer of the thermal energy withdrawn from a medium to a medium elsewhere or in a different method step. The heat transfer medium, as described above, may be a cooling fluid, especially a cooling liquid, e.g. water. The heat transfer medium may be spatially separated from the process gas; for example, the heat transfer medium may circulate in a cooling circuit spatially separate from the process gas. More preferably, several cooling stages in one condensation step have a respective heat transfer medium, for example has a first heat transfer medium in the first cooling stage and a second heat transfer medium in the second cooling stage. The cooling stages may optionally also have respectively separate cooling circuits. The heat withdrawn from the process gas in the cooling operation can then be at least partly fed back to the process gas in a further treatment step. The displacement of heat may thus take place between the condensation step and the further treatment step by means of the heat transfer medium, i.e. may transfer thermal energy from the process gas from the condensation step to the further treatment step. The heat transfer medium, especially a cooling liquid, may thus assure a high cooling performance in the cooling stage. In particular, the cooling performance in an air-water heat exchanger may be higher than an air-air heat exchanger. Preferably, even in the first cooling stage, a heat transfer medium is used for cooling of the process gas, where the heat withdrawn from the process gas in the first cooling stage is added again to the process gas in a further treatment step. The displacement of heat can simply be implemented by means of pumped circulation of cooling media. The displacement of heat can optionally also be implemented by means of a heat pump or a heat pipe.

The method of examples disclosed herein examples disclosed herein is preferably suitable for treatment of process gas that was involved in an industrial process, for example in the drying of a coating for production of lithium ion batteries or constituents thereof, especially of electrodes, separators and/or membranes for secondary batteries or fuel cells. The main stream preferably constitutes a continuous flow of the process gas in the method. The main stream preferably comprises the stream which is guided from the industrial process to the first condensation step, i.e. preferably the majority, more preferably the entire gas stream of the process gas conducted to the first condensation step. The spatial extent of the main stream especially also encompasses that flow space in which the first condensation step takes place. In linguistic analogy, this is also the case for the flow space of the secondary stream in which the stream interacts with a solid, for example, in the case of a concentrator or filter. For example, this is especially the case in which an adsorber is used.

In a preferred configuration of examples disclosed herein, the first further treatment step comprises a heating operation and/or a pressure-lowering operation, and/or feeding of gas outside the main stream, especially of air from an environment. At least a portion of the process gas is treated by the following method step: recycling of process gas downstream of the first condensation step into the industrial process. The expression “downstream of the first condensation step” should especially be considered to mean “downstream of the first condensation step in flow direction”; in particular, the operation can only be conducted downstream of the first further treatment step.

The gas from outside the main stream may, for example, at least partly be the process gas from one or more industrial process(es). Likewise conceivably, the gas may come at least partly from at least one branched-off secondary stream in which the gas flowing in the secondary stream has been subjected to further treatment or conditioning. In particular cases in which the ambient temperature and/or relative saturation of the ambient air is below a particular value, i.e. when, for example, the ambient air is dry or hot and dry enough, it may be preferable to supply ambient air to the process gas, in order, for example, to lower the relative saturation in the first further treatment step.

The first further treatment step after the first branching operation can precondition the process gas, especially for use in an industrial process, and reutilize the process gas in an energetically advantageous manner, i.e., for example, heat the process gas via a heat recovery from a condensation step. The industrial process may preferably be within the scope of a recirculation of the process gas from the industrial process from which the process gas has been fed to the first condensation step. However, it may also be advisable to feed the process gas to a further industrial process. In the case of operation with advantageous ambient air temperatures, which allows a desired temperature and/or relative saturation to be established when ambient air is fed into the main stream, this desired state of the process gas can optionally or alternatively be achieved by means of simple supply of ambient air even without heating in the first further treatment step.

In a further preferred configuration of examples disclosed herein, a portion of the process gas, in a second branching operation that takes place after the first branching operation, especially after the first further treatment step, is branched off from the main stream and added to the offgas, where the relative saturation of the offgas branched off in the second branching operation is lower than the relative saturation of the offgas branched off in the first branching operation. In particular, a measurement of the temperature and/or the saturation may be made after the portion of the process gas branched off in the second branching operation is added to the offgas. It is preferably possible using the temperature and/or saturation measured to adjust a flow rate of the process gas branched off in the second branching operation.

After the first branching operation, the offgas may still be saturated. The offgas may especially be saturated with a gas mixture, for example a gas mixture comprising steam and at least one gaseous solvent. Relative saturation may thus generally include relative saturation of the steam and/or relative saturation of the gaseous solvent. The offgas branched off in the first branching operation may thus have high relative saturation. The handling of a stream having high relative saturation may be made more difficult because of the risk of condensate formation, for example on the surface of conduits or channels. In the second branching operation, process gas is preferably branched off from the main stream, having been heated beforehand, for example, in the first further treatment step. After the process gas is heated, the heated process gas may then have lower relative saturation than the relative saturation of the offgas that has been branched off from the process gas beforehand in the first branching operation. This heated partial process gas stream may be added to the saturated offgas and lower the relative saturation thereof overall. The risk of condensate formation can thus be reduced. The addition of offgas may also comprise mixing-in or admixing. In particular, in the case of addition of branched-off process gas, a homogeneous flow property of the offgas may be established.

In a further preferred configuration of examples disclosed herein, at least a portion of the offgas is treated by the following method steps: firstly, a second condensation step which takes place after the first condensation step and in which a second condensate is separated out of the process gas. Secondly, a second further treatment step which takes place after the second condensation step and in which at least a portion of the offgas is subjected to further treatment after the second condensation step, comprising a heating operation and/or a pressure-lowering operation and/or a filtering operation; and/or thirdly, a deconcentration step which takes place after the first condensation step and comprises at least one deconcentration stage for lowering the concentration of a pollutant, and/or fourthly, a filtering of the offgas that takes place after the first condensation step. Supplementarily or electively, a portion of the branched-off offgas may be released into the environment after the first condensation step. This may especially be the case in water-based industrial processes. In the second condensation step, it is especially possible to separate out a condensate, preferably with the aid of a demister, i.e. a separation apparatus for separating out water droplets entrained in the offgas. The filtering of the offgas may also preferably take place after the second condensation step.

The second further treatment step, analogously to the first further treatment step, may also comprise supply of heat, lowering of pressure and/or a second feed of ambient air or process gas from outside the main stream, for example from a secondary stream. More preferably, in the second further treatment step, heat is supplied, where the thermal energy has been obtained from the second condensation step. The supply of heat in the second further treatment step can thus be regarded as a recovery of heat.

The lowest temperature of the offgas attained in the second condensation step may especially be lower than the lowest temperature of the process gas attained in the first condensation step. For the recovery of solvent-containing condensate from the secondary stream, it may be advantageous to additionally treat the offgas with the second condensation step, where the process gas in the second condensation step is cooled down to a lower temperature than in the first condensation step. Viewed overall, it is possible with this arrangement of examples disclosed herein to separate a higher proportion of solvents from the process gas than is possible by a single condensation step. Especially with TEP/EAA as solvent constituents in the process gas, it is preferably possible to cool down the offgas in the second condensation step to below 0° C., more preferably below −5° C., −10° C., −15° C.

Typically, the deconcentration step in the context of examples disclosed herein is effected as an adsorption process by means of an adsorption wheel or adsorption carousel, where atoms or molecules of liquids or gases are adsorbed onto a solid surface. A deconcentrator in the context of examples disclosed herein may as an apparatus having a housing within which there is disposed at least one adsorption wheel or adsorption carousel for lowering the pollutant concentration of an offgas.

The offgas is more preferably filtered after the second condensation step or after the deconcentration step. This method step may be optional if the pollutant concentration is already below the legal emission limits after the second condensation step or after the deconcentration step.

Likewise conceivable is the treating of a portion of the offgas with the second condensation step and of a further portion of the offgas with the deconcentration step. Such a process arrangement may especially be advantageous when different pollutant constituents that can either be removed more effectively from the offgas by means of a condensation step or by means of adsorption are present in the process gas.

The process gas may be a gas mixture, wherein at least one constituent can be condensed out. In particular, such a constituent comprises a solvent. A solvent constituent may, for example, be N-methyl-2-pyrrolidone (NMP), N-ethyl-2-pyrrolidone (NEP), triethyl phosphate (TEP), ethyl acetoacetate (EAA), dimethylacetamide (DMAc), γ-butyrolactone (GBL), propylene carbonate (PC) or else water, acetone or alcohol.

In a further preferred configuration of examples disclosed herein, the following method steps are conducted for desorption of a deconcentrator: firstly, a portion of the offgas is branched off before and/or after deconcentration in a deconcentration stage. Secondly, heating of the branched-off portion of the offgas to give a desorption gas. Thirdly, a desorption step by means of the desorption gas, wherein the desorption gas flows through a desorption region of a deconcentrator and takes up at least one adsorbed pollutant. Fourthly, the desorption gas is removed as concentrate gas after flowing through the desorption region. Fifthly, the concentrate gas is conducted to a condensation step, especially to the first condensation step and/or to a further condensation step, and/or a deconcentration step. The branched-off portion of the offgas may especially be heated up to a temperature suitable for desorption, i.e. to a desorption temperature, which produces the desorption gas.

The deconcentrator to be desorbed may preferably be the deconcentrator that cleans the offgas, where the offgas has been branched off from the main stream beforehand. Likewise preferably, the deconcentrator to be desorbed may be arranged parallel to a further deconcentrator, where the offgas coming from the main stream is divided into at least two substreams.

In principle, it is conceivable that the offgas is divided into at least two substreams, and the substreams are each guided to a deconcentrator. In this case, the offgas substreams come from a single main stream that has been treated with the first condensation step beforehand.

In principle, it is also possible for multiple industrial processes to proceed in parallel and for there to be an arrangement of several mutually parallel first condensation steps. In this case, multiple offgas streams that have each been branched off from a specific main stream are conducted to a deconcentration step. The deconcentrator to be desorbed may thus also be a further deconcentrator that treats a process gas which comes from a separate industrial process.

The portion of the offgas branched off from the deconcentration stage may be referred to as “dirty gas”. The portion of the offgas branched off downstream of the deconcentration stage may in turn be referred to as “clean gas”. The desorption gas may thus be branched off in the form of dirty gas or clean gas. The desorption gas used may also be fresh air from an environment, where the fresh air is heated to a desorption temperature and hence desorption gas is generated. Since pollutant is removed from the offgas in a deconcentration stage, the pollutant concentration of the offgas may be higher upstream than downstream of a deconcentration stage. The pollutant concentration of the dirty gas may thus also be higher than the pollutant concentration of the clean gas.

In the method of desorbing a deconcentrator, the desorption gas, after being heated up, will be passed through a desorption region of the deconcentrator and will take up adsorbed pollutant before the desorption gas is removed from the desorption region as concentrate gas. When dirty gas rather than clean gas is branched off as desorption gas, it is thus possible for the desorption gas to contain more pollutant and for the concentrate gas to correspondingly have a higher pollutant concentration. This may be advantageous when the concentrate gas to a condensation step, where the condensation step is effected by means of a concentrate gas condenser, because correspondingly more pollutant can be separated out as condensate. A further advantage of the use of dirty gas as desorption gas could be lower apparatus complexity. A concentrate gas condenser may especially be a condenser that treats predominantly or exclusively concentrate gas. More preferably, the concentrate gas is guided to the first condensation step and added to the process gas before the first condensation step.

In an alternative use scenario, it is also advantageously possible to branch off clean gas as desorption gas. The desorption gas, as elucidated above, may then contain less pollutant in the form of clean gas rather than dirty gas. This may be advantageous, for example, when the desorption capacity of the desorption gas is to be enhanced. The desorption gas may correspondingly take up more pollutant as it flows through the desorption region and better clean the deconcentrator.

It may also be advantageous in a further alternative use scenario when the desorption gas, after flowing through the desorption region as concentrate gas, is guided to a deconcentration step. The concentrate gas is preferably guided to the deconcentration step, more preferably to the first deconcentration stage of the deconcentration step. Because the desorption gas is in the form of clean gas rather than dirty gas, the pollutant concentration of the concentrate gas may be lower and subject the deconcentrator to correspondingly lower stress in the deconcentration stage.

In a further preferred configuration of examples disclosed, the following method steps are conducted: firstly, a concentrate gas is generated after flowing through the desorption region of a deconcentrator. Secondly, the concentrate gas is treated in a condensation step and/or deconcentration step. Thirdly, the treated concentrate gas is guided to the first condensation step and/or to a deconcentration step, especially to the first stage of the deconcentration step, and/or divided into at least two substreams before at least one of the substreams of the treated concentrate gas is guided to a condensation step and/or to a deconcentration step.

In this configuration, the concentrate gas may first be treated in a condensation step using a concentrate gas condenser. Alternatively, the concentrate gas is first treated in a deconcentration stage of a deconcentration step. The treated concentrate gas can be guided to the first condensation step; in particular, the treated concentrate gas can be added to the process gas before the first condensation step. The treated concentrate gas is preferably divided into two substreams, for example, where one substream is to the first condensation step and a further substream to another condensation step, for example a condensation step using a concentrate gas condenser. It is likewise conceivable that one substream is guided to the first condensation step and a further substream to the first deconcentration stage of the deconcentration step.

In a further preferred configuration of examples disclosed herein, a deconcentration step comprises at least two deconcentration stages arranged in succession in flow direction of the offgas, wherein each of the deconcentration stages has a deconcentrator, wherein a concentrate gas from a deconcentration stage downstream of at least one deconcentration stage is treated by the following method steps: the concentrate gas is mixed with the concentrate gas from an upstream deconcentration stage; and/or the concentrate gas is condensed in a condensation step and removed by means of a further concentrate gas conduit downstream of the condensation step; and/or the concentrate gas is guided to a deconcentration stage, especially to the foremost deconcentration stage; and/or the concentrate gas is guided to the first condensation step.

This configuration of examples disclosed herein relates in particular to an advantageous gas flow regime of the concentrate gas from a downstream deconcentration stage for desorption of a deconcentrator. This downstream deconcentration stage is thus disposed downstream of a further deconcentration stage in relation to the main flow direction of the offgas. For example, this relates to the second stage in a two-stage deconcentration step, and to the second and third stages in a three-stage deconcentration step.

The concentrate gas from the downstream deconcentration stage can be mixed with the concentrate gas from an upstream deconcentration stage, i.e. the two concentrate gas streams can be combined. The volume flow rate of concentrate gas can thus be increased, and it is especially possible to increase the effectiveness of treatment of the combined concentrate gas streams. The concentrate gas is preferably condensed in a condensation step, for example in a concentrate gas condenser, wherein a pollutant-containing condensate can be separated out of the concentrate gas. The method with a condensation step in the concentrate gas condenser may especially have the advantage when multiple concentrate gas streams are combined. The concentrate gas condenser can correspondingly separate out more pollutant-containing condensate. Nevertheless, the dimensions of the concentrate gas condenser can be designed advantageously for a greater throughput volume.

It would likewise be conceivable for there to be greater cooling of the concentrate gas condenser which is designed for smaller throughput volumes of concentrate gas.

Greater cooling in the condensation step by means of the concentrate gas condenser can increase the pollutant-containing fraction in the separated condensate and improve the recovery of solvent-containing pollutant. Because of the smaller dimensions of the concentrate gas condenser, it is possible to reduce energy expenditure.

Likewise preferably, the concentrate gas is conducted to a deconcentration stage of a deconcentration step, more preferably to the foremost deconcentration stage of the deconcentration step, i.e. to the first deconcentration stage in relation to the main flow direction of the offgas. The foremost deconcentration stage may especially be designed for deconcentration of a relatively high pollutant concentration, and therefore the concentrate gas is advantageously preferably conducted thereto.

Likewise more preferably, the concentrate gas is conducted to the first condensation step. The concentrate gas can be added here to the process gas upstream of the first condensation step, and the pollutant concentration of the process gas can be increased before the first condensation step. The separating-out of a maximum amount of pollutants in the first condensation step can thus be configured advantageously. This is particularly advantageous when the concentrate gas contains solvent-containing pollutant that can be recovered by means of a condensation step. In particular, as described above, in the cooling operation, a thermal recovery can be coupled to the first condensation step. By conducting the concentrate gas to the first condensation step, it is possible to recover a portion of the thermal energy from the concentrate gas.

In a further preferred configuration of examples disclosed herein, a deconcentration step comprises at least two deconcentration stages arranged in succession in flow direction of the offgas, wherein each of the deconcentration stages has a deconcentrator, wherein a concentrate gas from a deconcentration stage upstream of a further deconcentration stage, in the case of three deconcentration stages or more, is arranged as the foremost deconcentration stage, is treated by the following method steps: the concentrate gas is mixed with the concentrate gas from a downstream deconcentration stage; and/or the concentrate gas is condensed in a condensation step before being removed by means of a further concentrate gas conduit after the condensation step; and/or the concentrate gas is guided to a deconcentration stage, especially to the foremost deconcentration stage; and/or the concentrate gas is guided to the first condensation step.

This configuration of examples disclosed herein relates in particular to an advantageous gas flow regime for desorbing in a deconcentration stage which is the foremost deconcentration stage in relation to the main flow direction of the offgas. The offgas is thus first treated with this foremost deconcentration stage in the treatment in the deconcentration step, before the offgas is treated in a further deconcentration stage downstream.

The gas flow regime of the concentrate gas in this configuration may be analogous to the above-described gas flow regime of the concentrate gas from the downstream deconcentration stage.

In a further preferred configuration of examples disclosed herein, especially on commencement of operation or in the event of interrupted operation or at the end of operation of the industrial process, at least a portion of the process gas is filtered and/or purged, preferably in full, after the first condensation step, especially after the first further treatment step, and then guided into the environment as offgas, with simultaneous guiding of fresh air from the environment to the industrial process.

Operation may be interrupted, for example, when an operating parameter for triggering interrupted operation is exceeded. The offgas is preferably first filtered after the first condensation step before the offgas is released into the environment. Likewise conceivably, the offgas is heated up after the first condensation step in the first further treatment step, but the heating in the case of use with an activated carbon filter is typically limited to below 50° C., before the offgas is filtered and discharged into the environment. The simultaneous introduction of fresh air from the environment can especially be effected in a compensatory manner, i.e. in a similar volume flow ratio, to the discharge of fresh air. The industrial plant in which the industrial process is effected can thus be purged with fresh air by this method, and the relative saturation in the industrial plant can be kept below a particular level.

Examples disclosed herein further relate to an apparatus for treatment of process gas from an industrial process, preferably for execution of an above process.

It is an object of examples disclosed herein to specify an advantageous apparatus for the treatment of process gas from an industrial process.

This object is achieved in accordance with examples disclosed herein by an apparatus for treatment of process gas from an industrial process, especially for execution of a method as claimed in any of the preceding claims, comprising an outlet for discharging process gas from an industrial process, a heating element for heating the process gas, an inlet for introducing process gas into a first condenser, having a first cooling unit for cooling process gas, a first branch site for branching off at least a proportion of process gas as offgas into a secondary stream channel, wherein the heating element is disposed downstream of the first branch site.

The heating element in this configuration may be a heat exchanger connected to the first cooling unit, which, as described above, is operated, for example, by means of a coolant for achievement of a displacement of heat. The heating element may alternatively be an electrical heating element which can optionally also be used in addition to a heat exchanger as heating element. The heating element may preferably be disposed in the first condenser. However, the heating element may also be connected to a heat source outside the first condenser and may also be disposed outside the first condenser.

A main flow or secondary flow channel in the context of examples disclosed herein may be considered to mean a flow channel through which a gas flow can be passed. A channel may also be a gas conduit or air conduit.

In a preferred configuration, the apparatus has a second branch site with which process gas is branched off into the secondary flow channel to lower the relative saturation of the offgas, where the first branch site is disposed downstream of the cooling unit and the second branch site is disposed downstream of the heating element.

The second branch site may preferably be disposed in the first condenser in order to achieve a compact build size. However, it may also be advantageous to guide the process gas to the heating element outside the first condenser and to branch off offgas there into the secondary flow channel by means of the second branch site.

In a further preferred configuration, the secondary flow channel, for introduction of at least a portion of the offgas, is connectable to: an inlet disposed downstream of the first condenser for introduction into a second condenser, where a second condensate is removed from the offgas; and/or an inlet disposed downstream of the first condenser for introduction into a deconcentrator for lowering the concentration of a pollutant; and/or an inlet disposed downstream of the first condenser for introduction into a filter, especially into an activated carbon filter.

In the context of this configuration, the offgas may be a process gas removed from the main flow channel. The offgas may, for example, be branched off from the main flow channel into the secondary flow channel at the first branch site and/or else at a second branch site. A portion of the offgas may alternatively have been removed from a process gas, for example from another industrial plant or condenser operated in parallel to the first condenser.

The secondary flow channel is preferably connected to the inlet of the second condenser. The second condenser is more preferably disposed downstream of the first condenser in relation to the main flow direction of the offgas. In the case of a multistage deconcentration step, several deconcentrators may be arranged in succession. In such a case, the secondary flow channel may be disposed between two deconcentrators, where an offgas treated in the front deconcentrator may be conducted through the secondary flow channel to the rear deconcentrator.

In a further preferred configuration for desorption of a deconcentrator, the apparatus has a branching apparatus for removal of a portion of the offgas, where the branched-off portion of the offgas is conducted to a heating unit in which desorption gas for desorption of the deconcentrator (80, 81, 85) is generated.

The branching apparatus may preferably be configured in the form of a box or chamber for deflection of a flow, a valve or a flap. The branching apparatus may preferably be disposed in a deconcentrator, for example as a valve or box within a deconcentrator. The branching apparatus may especially branch off or deflect a portion of the offgas, where the branched-off portion of the offgas is guided into a separate gas channel to the heating unit. In the heating unit, the branched-off portion of the offgas is preferably heated to a desorption temperature, generating desorption gas. The desorption gas may preferably leave the heating unit by means of a desorption gas conduit.

In a further preferred configuration, the apparatus has a deconcentrator having at least one adsorption region and one desorption region, a concentrate gas conduit for guiding concentrate gas from the desorption region to an inlet for introduction of concentrate gas into the first condenser and/or into a concentrate gas condenser and/or into an adsorption region of a deconcentrator.

The deconcentrator preferably has an adsorption region, a desorption region and a cooling region for cooling a subregion of the adsorption wheel.

In a further preferred configuration, the apparatus has at least two deconcentrators arranged in succession based on the flow direction of the offgas, each of which has at least one adsorption region and one desorption region, a second concentrate gas conduit for removal of concentrate gas from the desorption region of a downstream deconcentrator, where the second concentrate gas conduit for introduction of the concentrate gas is connectable to: an inlet for introduction into an adsorption region of a deconcentrator; and/or a first concentrate gas conduit of an upstream deconcentrator for mixing with the concentrate gas therefrom; and/or the inlet for introduction into the first condenser and/or an inlet for introduction into a concentrate gas condenser.

In a further preferred configuration, a further concentrate gas conduit for introduction of a concentrate gas treated in a condenser and/or deconcentrator is by an inlet for introduction into the first condensation step and/or an inlet for introduction into a deconcentrator, and/or a divider, wherein the treated concentrate gas is divided into at least two substreams before at least one of the substreams of the treated concentrate gas is conducted by an inlet for introduction into a condenser and/or into a deconcentrator.

In a further preferred configuration, the apparatus has at least two deconcentrators arranged in series based on the flow direction of the offgas, each of which has at least one adsorption region and one desorption region, a first concentrate gas conduit for removal of concentrate gas from the desorption region of an upstream deconcentrator, in the case of at least three deconcentrators the foremost deconcentrator, where the first concentrate gas conduit, for introduction of the concentrate gas, is connectable to: an inlet for introduction into the adsorption region of a deconcentrator; and/or an inlet for introduction into a concentrate gas condenser; and/or the second concentrate gas conduit of a downstream deconcentrator for mixing with the concentrate gas therefrom; and/or the inlet for introduction into the first condenser.

Examples disclosed herein are usable in principle for any industrial plants and industrial processes that use process gas. The applications specified by way of example above with regard to the technical background are also applicable to the apparatuses and methods of examples disclosed herein. Advantageously, the apparatus of examples disclosed herein
and the method of examples disclosed herein may be used for treatment of a circulating process fluid or of process air from a dryer, especially circulated air from a dryer, especially from the process air of a manufacturing plant for production of electrodes of a battery. This is typically accomplished in a manufacturing plant for production of an electrical power storage medium which is removed from a drying plant, in which electrodes are dried after a coating operation.

### Working Examples

Examples disclosed herein are elucidated in detail hereinafter with reference to multiple working examples, without specific distinction between the individual claim categories. In addition, it is made clear that the proposed solutions to problems in accordance with the invention can be applied to various different industrial processes in which, for example, an inert gas is employed as process gas. Process air from an industrial process for production of electrodes of a battery is treated in accordance with the invention hereinafter by way of example.

### BRIEF DESCRIPTION OF THE DRAWINGS

The drawings show:

FIG. 1 a schematic diagram of an apparatus of examples disclosed herein having a first condenser and a second condenser for treatment of process air from an industrial process for drying of an electrode coating;

FIG. 1a a schematic diagram of a method of examples disclosed herein for treatment of process air according to FIG. 1;

FIG. 2 a schematic diagram of an apparatus of examples disclosed herein for treatment of branched-off waste air by means of one deconcentrator;

FIG. 2a a schematic diagram of a method of examples disclosed herein for treatment of branched-off waste air according to FIG. 2;

FIG. 3 a schematic diagram of an apparatus of examples disclosed herein for treatment of branched-off waste air by means of two deconcentrators;

FIG. 3a a schematic diagram of a method of examples disclosed herein for treatment of process air according to FIG. 3.

### DETAILED DESCRIPTION

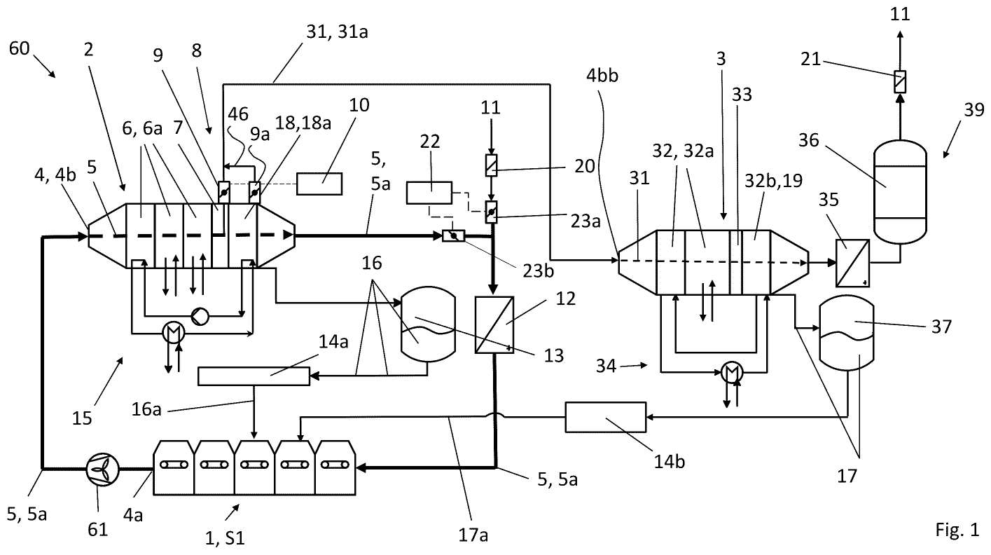

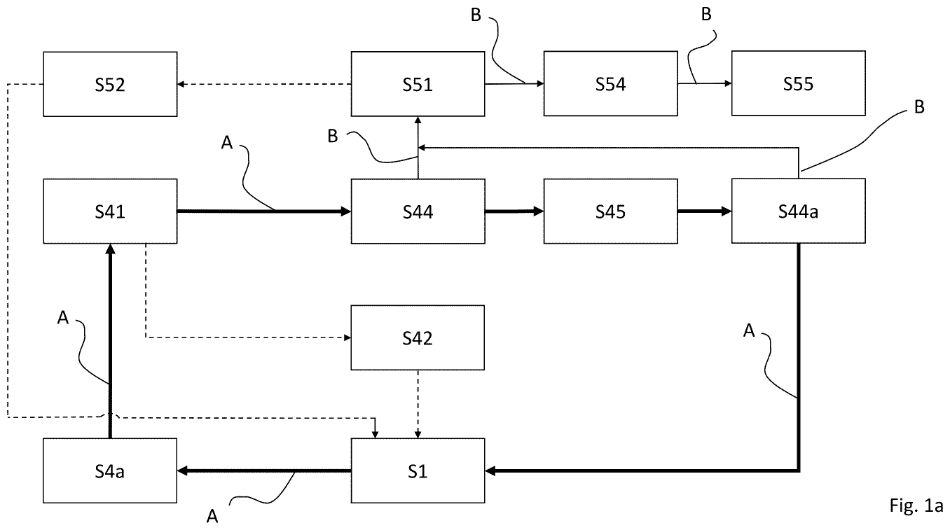

FIG. 1 shows a schematic of a working example of an apparatus of examples disclosed herein for treatment of process air from an industrial process for production of lithium ion batteries.

Reference numeral 1 indicates an illustrative electrode coating plant in which electrodes for production of lithium ion batteries are coated in an electrode coating process S1. It is possible here, for example, for one of the abovementioned solvents to be used; in particular, the solvent used may also be a mixture of, for example, TEP and EAA. A process air A from the electrode coating process S1 is conveyed from an outlet 4a by a fan 61 into the main flow channel 5a to a first condenser 2. The fan 61 may optionally also be disposed between the condenser 2 and a first air heater 12. A temperature of the process air A is typically about 120° C., for example in a range between 100 and 150° C., on entry into the first condenser 2. In a first cooling unit 6, the process air A is gradually cooled down, preferably to about 15° C. as target temperature. The first cooling unit 6 optionally has a three-stage or multistage heat exchanger 6a in which heat is removed from the process air. In the working example, the process air A is cooled down in the three-stage heat exchanger 6a to 60° C. after the first stage, to 30° C. after the second stage, and to 15° C. after the third stage. However, it may also be the case that the process air is cooled down to about 10, 11, 12, 13 or 14° C. as target temperature. In the first stage of the heat exchanger 6a, the process air is cooled down, for example, from 120° C. on entry to typically about 60° C., to about 40° C. for example in the second stage, and finally to the target temperature in the third stage. The heat removed in the first stage is transferred via a heat displacement apparatus 15 to a first heating element 18 in the form of a heat exchanger. The heat displacement apparatus 15 may alternatively or additionally also have, for example, a heat pump, heat conductor, or the like. A heat conductor may be designed, for example, as a heat pipe, where thermal energy is transported by means of a solid of good thermal conductivity. Preferably, heat transfer medium is circulated in the heat displacement apparatus 15, where thermal energy is transported from the first cooling unit 6 to the first heating element 18. The first heating element 18 serves to return the heat withdrawn in the heat exchanger 6a back to the process air A. The heat removed in the second and third stages is also optionally fed to a further process (not shown) via separate heat displacement apparatuses; for example, it is possible to implement coupling of the heat into the electrode coating process S1.

The heat exchanger 6a, for each stage, has a heat sink having preferably vertical cooling fins, through which the process air A is passed. The cooling gives rise to the first condensate 16 at the surface of the cooling fins, which is then led off by gravity into a collecting vessel disposed beneath the first cooling unit 6. As a result of the cooling in the first cooling unit 6, aerosol formation occasionally occurs. This gives rise to aerosols that are transported through the first condenser 2 with the main stream 5. Beyond the first cooling unit 6 is therefore preferably disposed a first separator 7 in the form of a “demister” or impact separator made from a wire mesh for separation of fine droplets. The process air A flows through the first separator 7, as a result of which first condensate 16 is obtained once again and is led off by gravity into the collecting vessel disposed beneath the first cooling unit 6.

The first condensate 16 separated out includes a first solvent 16a which may, for example, comprise a mixture of TEP and EAA together with various by-products having similar condensation properties. The first condensate 16 is pumped out of the collecting vessel into a first condensate collector 13 outside the first condenser 2 and processed in a condensate reprocessing plant 14a for recycling into the electrode coating process 1a, preferably by distillation, with separation of the first condensate 16 into its respective solvent constituents (TEP and EAA) and enrichment thereof in the condensate reprocessing plant 14a.

Downstream of the first separator 7, a portion of the process air A is branched off from the main stream 5 at a first branching site 9 by a valve of a diverting apparatus and diverted or led off as waste air B into the secondary flow channel 31a to a second condenser 3. The portion of the process air conducted within the secondary flow channel 31a is preferably also referred to hereinafter as waste air B. A further portion of the process air A present in the main stream 5, which has already been heated up by means of the heating element 18a, is branched off into the secondary flow channel 31a with an auxiliary conduit 46 connected at a second branching site 9a downstream of the first branching site 9, and fed into or admixed with the waste air present in the secondary flow channel 31a. The volume of process air A branched off via the auxiliary conduit 46 is adjusted by means of a valve of the diverting apparatus 8. Rather than at least one of the valves, it is equally possible for a valve or throttle to be provided at at least one branching site. For example, a throttle may be used at the first branching site, and an adjustable valve for adjustment of the relative saturation of the waste air B at the second branching site. By the supply of a proportion of (re) heated process air A, it is possible in particular to lower the relative saturation of the waste air B in the secondary flow channel 31a or to increase the temperature of the waste air B in the secondary flow channel 31a and to facilitate handling or further treatment thereof. For example, it is thus possible to prevent unwanted condensation. In this way, it is additionally possible to branch off process air A at the second branching site 9a and to admix it with the waste air B previously at the first branching site 9. The temperature of the waste air B can be raised by the admixing, for example, from 15° C. to about 20° C. While the waste air B branched off at the first branching site 9 in the coldest zone of the condenser 2 is virtually 100% steam- and/or solvent-saturated, the relative saturation of the process air A branched off at the second branching site 9a is significantly lower, while the temperature thereof is comparatively higher. Therefore, the waste air B formed from the two substreams has a reduced relative saturation of steam and, if appropriate, the solvent in addition of preferably not more than 80% or less. The volume flow rate at the second branching site 9a can preferably be adjusted by means of a closed-loop control unit, with implementation of a measurement of temperature, saturation and/or solvent concentration.

A second cooling unit 32 is an essential component of the second condenser 3 and has an at least two-stage heat exchanger 32a in which heat, especially further heat, is removed from the waste air B. In the first stage, the waste air B is cooled down, for example, from 20°° C. to −5° C., and to −20° C. in the second stage. It is optionally possible under some circumstances to add further stages in order to cool down the waste air B to a target temperature below 0° C. Because the waste air B is cooled down to <0° C., it may be particularly preferable to use a further second cooling unit in a parallel arrangement. The further second cooling unit may, for example, assume the function of cooling the waste air B in a deicing operation on the second cooling unit 32. The heat removed in the first stage is transferred via a heat displacement apparatus 34 to a second heat element 19 in the form of a heat exchanger. By means of the second heating element 19, the heat withdrawn beforehand is at least partly added again to the waste air B in the secondary stream 31. The heat removed in the second stage, if required, is fed to a further process (not shown) via a separate heat pump. Both the separation of a second condensate 17 and the configuration of a second heat exchanger 32a and a second separator 33 (demister) are preferably analogous to the case of the first condenser 2. The second condensate includes a second solvent 17a, where the second solvent 17a may have any composition (of, for example, TEP and EAA). The second condensate 17, just like the first condensate 16, is pumped out of the collecting vessel (not shown in FIG. 1) into the second condensate collector 37 outside the second condenser 3 and processed in a condensate reprocessing plant 14b for recycling into the electrode coating process 1a, especially by distillation, in which condensate reprocessing plant 14b the second condensate 17 is separated into its respective solvent constituents (e.g. TEP and EAA) and enriched.

Downstream of the second separator 33, the waste air B in the secondary stream 31 is heated up to 10° C. by the second heating element 19 with the recovered heat from the second heat exchanger 32a. A second air heater 35 is disposed downstream of the second condenser 3, by means of which the waste air B is then heated up again to 15°° C. before the waste air B is guided into a second further treatment apparatus 39. In the second further treatment apparatus 39, the waste air B, in the example according to FIG. 1, is filtered through an activated carbon filter 36 before ultimately being released into the environment 11 via an air outlet 21.

Going back to the process air circuit of the main stream 5: downstream of the separator 7, the process air A in the main stream 5 is heated again from about 15° C. to about 60° C. by the first heating element 18. In the example according to FIG. 1, the process air A that leaves the first condenser 2 is guided to a first air heater 12 by means of the main flow channel 5a for further conditioning.

The main flow channel 5a of the example according to FIG. 1 additionally has a second and third valve 23a, 23b. These valves 23a, 23b are controlled by open-loop or closed-loop control by a second control unit 22 that can communicate with the first control unit 10. Alternatively, the valves may also be adjusted manually. The second valve 23a is preferably intended to control an air volume from the environment 11 through an air inlet 20 and in so doing to adjust a flow rate to the main flow channel 5a. In normal operation, the air inlet 20 can remain closed. Air inlets may be disposed in the electrode coating plant 1 in the form of “web slots”, such that an air volume fed to the electrode coating process 1a via the web slots preferably corresponds to an air volume branched off into the secondary flow 31. Web slots are typically slots in the housing through which, for example, a coated foil is conducted. However, especially in the case of interrupted operation, the third valve 23b may also be closed completely; and the process air A may be guided completely by means of a valve (not shown) to a filter (not shown), especially to an activated carbon filter, and filtered before the process air A is released into the environment as waste air B. At the same time, the second valve 23a is opened, with conduction of fresh air from the environment to the industrial process by way of compensation for the waste air B removed. This method may, for example, also be employed at the start of operation and/or at the end of operation.

The fresh air fed in from the environment 11 and the process air A from the condenser 2 are directed by means of the main flow channel 5a through the first air heater 12 in which the air is preheated or heated for the electrode coating process 1a and ultimately conducted back into the electrode coating plant 1.

FIG. 1a shows a schematic of an example of a method of examples disclosed herein for treatment of process air from an industrial process for production of lithium ion batteries. In the method according to FIG. 1a, an electrode coating process S1 takes place, wherein a solvent or solvent mixture, for example a combination of TEP and EAA (referred to hereinafter as TEP/EAA solvent), is preferably used. The process air is used to dry the wet electrode coating contained TEP/EAA solvents, especially in order to drive the solvent out of at least one coating plant.

By the method of examples disclosed herein, the process air A in a main stream 5 is guided to a first condensation step S41. Before the condensation step S41, the process air A is preferably filtered. A filtration step S4a serves to separate the process air A from coarse particles that have formed in the electrode coating process S1 and/or have been entrained therefrom by the flowing process air A. In the first condensation step S41, the process air A is cooled down gradually from, for example, about 120° C. on entry into the first condensation step S41 down to about 15° C. In this way, a first condensate 16 is separated out of the process air A, which is fed to a first recovery process S42. In the first condensation step S41, the process air A can be cleaned such that the concentration of TEP/EAA solvents in the process air A can be reduced from typically about 4000 ppm on entry into the first condensation step to, for example, about 300 ppm on exit (i.e. reduced by a factor greater than 10). In the recovery process S42, the first condensate 16 is collected and also preferably treated by a distillation and condensate reprocessing operation (not shown). This converts the first condensate 16 containing TEP/EAA solvents, for example, to a first enriched condensate 16a. If required, the TEP/EAA solvent can also be separated into the different solvent constituents (TEP and EAA) in the recovery process S42. Preferably, enriched condensate 16a and/or the solvent constituents are subsequently fed back to the electrode coating process S1.

After the process air A in the main stream 5 has been treated by the first condensation step S41, waste air B is branched off into a secondary stream 31 from the main stream 5 via a first branching operation S44, and this is then guided to a second condensation step S51. The volume flow branched off into the secondary stream 31 typically corresponds to about 10% of the volume flow rate present that remains in the main stream 5 after the first branching operation S44 and is conducted to a first further treatment step S45.

The process air A, after the first branching operation S44, is conditioned in a first further treatment step S45, in particular by first warming or heating the process air A, then optionally supplementing it with air from the environment and then preferably heating it further. This in particular lowers the relative saturation of the process air A. After the first further treatment step S45, a portion of the process air A is branched off from the main stream 5 in a second branching operation S44a and added to the waste air B conducted to the second condensation step S51. In particular, the relative saturation of the waste air B conducted to the second condensation step S51 can be lowered overall by admixing a portion of process air A treated by the first further treatment step S45 that has a lower relative saturation with the waste air B. The volume flow branched off in the second branching operation S44a typically corresponds to less than 15%, preferably less than 10%, more preferably less than 5%, of the available volume flow that remains in the main stream 5 after the second branching operation S44a.

The process air A remaining in the main stream 5, after the second branching operation S44a, is fed back to the electrode coating process S1. The main stream 5 is also called recirculation stream or “makeup air”.

After the first branching operation S44, the waste air B is conducted to the second condensation step S51. The waste air B is preferably at a temperature of 20° C. on entry into the second condensation step S41. The waste air B is gradually cooled therein down to −20° C., for example, where a second condensate 17 is separated out of the waste air B and fed to a second recovery process S52. In the second condensation step S51, the waste air B can be cleaned such that any concentration of TEP/EAA solvents (or other solvents, e.g. NMP, GBL, etc.) in the process air can be reduced from typically about 300 ppm on entry to typically about 50 ppm on exit.

In the recovery process S52, the second condensate 17 is collected and also treated by a distillation and condensate reprocessing operation (not shown). This involves processing the second condensate 17 to give a second enriched condensate 17a which contains TEP/EAA solvents in particular, separating it into the respective solvent constituents (TEP and EAA) in particular and feeding them back to the electrode coating process S1.

The waste air B present in the secondary stream 31 is treated by a second further treatment step S54 after the second condensation step S51. The waste air B is first adjusted to a temperature of 20° C., then filtered and finally discharged into an environment via a discharge step S55. This is because the filtering in the second further treatment step S54 ensures that solvent constituents in the waste air B are removed in order that legal emission limits can be observed.

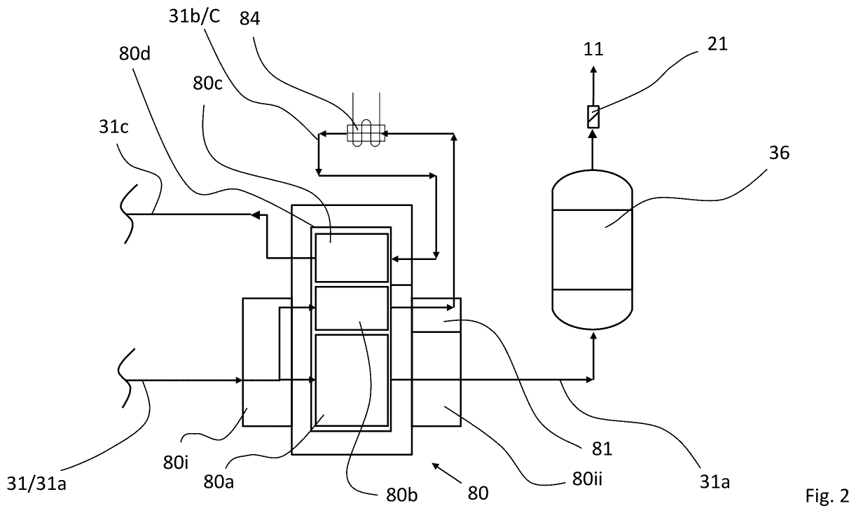

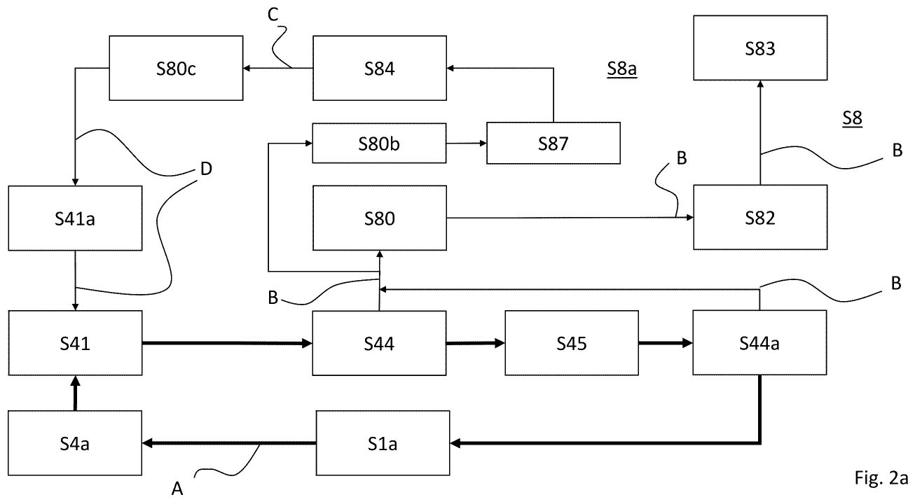

FIG. 2 shows a schematic of an alternative design for treatment of waste air by means of a deconcentrator 80 in an apparatus of examples disclosed herein, wherein the waste air has been branched off from the main stream 5 in a first and second branching operation.

By contrast with FIG. 1, the secondary flow channel 31a is connected to an inlet 80i of the deconcentrator 80. The waste air B is guided to the deconcentrator 80. The deconcentrator 80 takes the form of an adsorption apparatus by way of example, where the deconcentrator 80 in the context of examples disclosed herein may be designed or function, for example, as a filter, as an electrostatic precipitator or as a sorptive separator. As indicated in FIG. 2, the sorptive deconcentrator 80 by way of example has an adsorption region 80a, a cooling region 80b and a desorption region 80c. There is at least one adsorber 80d in the deconcentrator 80, and this is rotatable/movable such that the sections thereof are present alternately in the adsorption region 80a or in the desorption region 80c. The adsorption region 80a is disposed between an inlet 80i and an outlet 80ii, such that the section of the adsorber 80d present in the adsorption region 80a adsorbs pollutants, especially solvents, from the waste air B flowing from the inlet 80i to the outlet 80ii. In the cooling region 80b, the section of the adsorber 80d that merges into the adsorption region 80a is cooled in order to enhance the adsorption effect.

The pollutants adsorbed in the adsorption region 80a can then be desorbed again from the adsorber 80d by rotation/movement of the adsorber 80d in the desorption region 80c and removed from the deconcentrator 80. The adsorbed pollutants are desorbed from the adsorber 80d using a desorption air C which flows through the desorption region 80c. In this working example, the desorption air C used is the waste air B, which is branched off from the secondary stream 31 by means of a branching apparatus 87 via a desorption air conduit 31b downstream of the deconcentrator 80 and then heated to a desorption temperature by means of a desorption air heater 84. As shown in FIG. 2, the waste air B first flows through the cooling region 80b of the deconcentrator 80 in order to cool down in the section of the adsorber 80d that merges into the adsorption region 80a before a portion of the waste air B is branched off and conducted to the desorption air heater 84. After being heated in the desorption air heater 84, the desorption air C flows through the desorption region 80c of the deconcentrator 80, as a result of which the adsorbed pollutants are parted or desorbed from the desorption region 80c of the adsorber 80d. After flowing through the desorption region 80c, the desorption air C is removed as concentrate air D. The concentrate air D is then guided by means of a concentrate air conduit 31c from the desorption region 80c into the main flow channel 5a and preferably guided to the first condenser 2. The connection point between the concentrate air conduit 31c and the main flow channel 5a thus serves as an inlet for introduction of concentrate air D into the first condenser.

Downstream of the deconcentrator 80 is preferably disposed an activated carbon filter 36 with which the waste air B is filtered before it is removed for discharge 21 into the environment 11.

FIG. 2a illustrates, by way of example, a method S8 of cleaning waste air by means of a one-stage deconcentration step.

After a portion of the process air A has been branched off from the main stream 5 in the respective method steps S44, S44a of the first and second branching operations, the waste air B is treated by means of a deconcentrator 80 in a deconcentration step S80, wherein pollutants are adsorbed from the waste air B and the concentration of the pollutant is lowered.

The method S8 of cleaning waste air B by means of a one-stage deconcentration step has the following method steps:
S80: The waste air B is cleaned by means of a one-stage deconcentration step, which lowers the pollutant concentration.
S80b: A portion of the waste air will at first absorb thermal energy by means of the cooling region 80b, and this will cool the cooling region 80b of the adsorber 80d, with an increase in particular in the temperature of the portion of the waste air owing to the heat transfer from the cooling region 80b from about 20 to 30° C. to about 100 to 140° C.
S82: The waste air B is filtered by means of an activated carbon filter, with lowering of the pollutant concentration.
S83: The filtered waste air B is removed to the environment.

First of all, the method steps for desorption of a deconcentrator 80 by means of what is called a dirty gas cleaning method S8a are elucidated. In the dirty gas cleaning method S8a, a portion of the waste air B is branched off before flowing through the adsorption region 80a for desorbing of the deconcentrator.

By contrast, it is also alternatively possible to conduct a clean gas cleaning method. In the clean gas cleaning method, a portion of the waste air B is branched off for desorbing, having been treated by means of the adsorption region 80a. In this case, after flowing through an adsorption region 80a of the deconcentrator 80, the waste air B treated by the deconcentrator 80 can be referred to as “clean gas”.

The dirty gas cleaning method S8a has the following method steps:
S87: A portion of the waste air B is branched off from the secondary stream 31 for desorbing of the deconcentrator 80.
S84: The branched-off portion of the waste air B is heated by means of a heating element, according to FIG. 2 in the form of a desorption air heater 84, and conducted as desorption gas C to the desorption region S80c.
S80c: After the heating in the prior method step, the desorption air C, in a desorption step S80C, will desorb the pollutant adsorbed in the adsorber 80d as it flows through the desorption region 80c of the deconcentrator 80 and remove it as concentrate air D.
S41a: The pollutant-containing concentrate air D, after the desorption step S80c, will be conducted to the treatment by the first condensation step S41 and will be admixed with the process air A in the main stream 5 before the process air A is treated in the first condensation step S41.

After the waste air B, as described above, has been treated by means of the deconcentrator 80 and a portion thereof has been branched off in process step S81, the remaining portion is filtered in a further process step S82 and then removed to the environment (S83).

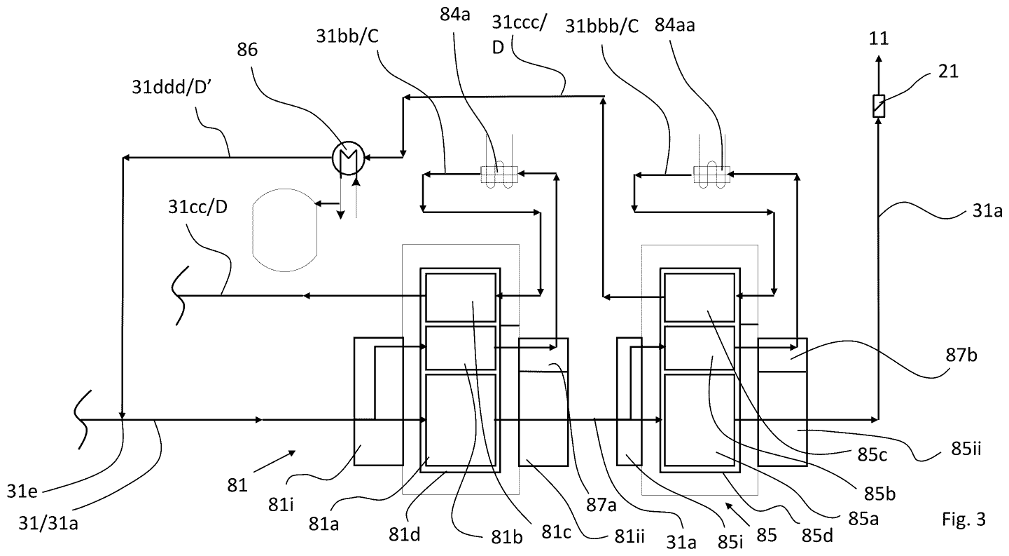

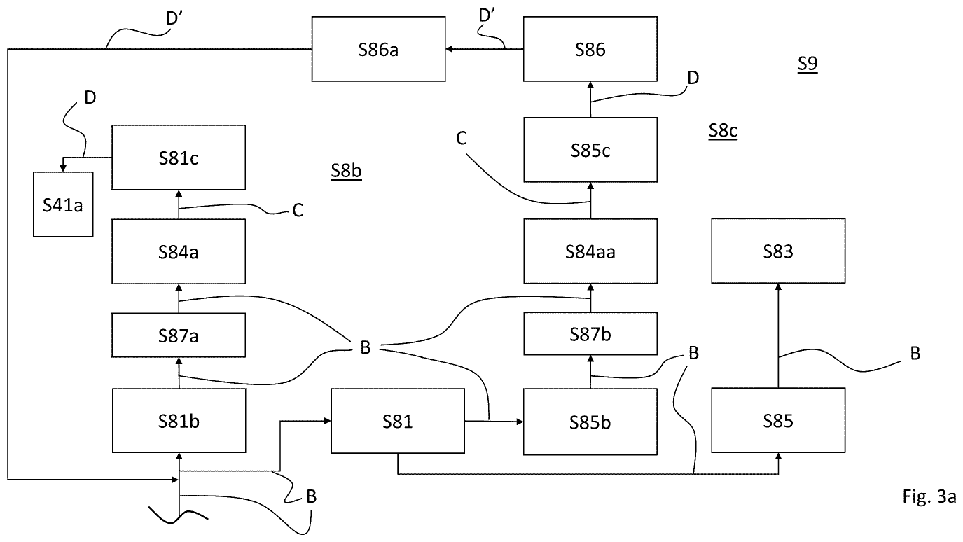

FIG. 3 shows a schematic of a further alternative execution for treatment of waste air from an apparatus of examples disclosed herein for treatment of the waste air branched off from the main stream 5 by means of two concentrators arranged in succession.

The second deconcentrator 85 is disposed downstream of the first deconcentrator 81 The first and second deconcentrators 81, 85 work analogously to the above-described deconcentrator 80. What should be emphasized in particular in this working example is the arrangement of the desorption air conduits and concentrate air conduits.

A portion of the waste air B is branched off by means of a branching apparatus 87a and conducted to the desorption air heater 84a. A portion of the waste air B, after entry in the deconcentrator 81, passes through the cooling region 81b, the desorption air heater 84a and the desorption region 81c before the desorption air C is removed from the desorption region 81c by means of a first concentrate air conduit 31cc. The further progression of the concentrate air conduit 31cc is analogous to the progression of the concentrate air conduit 31c described in FIG. 2. The concentrate air conduit 31cc is connected to the main flow channel 5a at a connection site, i.e. at an inlet for introduction of concentrate air D into the first condenser 2, where concentrate air is passed into the main flow channel 5a and conducted to the first condenser 2.

The deconcentrators 81, 85 work analogously to the deconcentrator 80 shown in FIG. 2. A portion of the waste air B is branched off to the desorption air heater 84aa. The air flow regime is analogous to that in the above example, with the branched-off portion of the waste air B being heated to a desorption temperature by means of the desorption air heater 84aa and conducted to the desorption region 85c as desorption air into a second desorption air conduit 31bbb. After flowing through the desorption region 85c, the desorption air C is removed as concentrate air D. The concentrate air D is then conducted by means of a second concentrate air conduit 31ccc from the desorption region 85c for treatment with a concentrate air condenser 86, with separation of a pollutant-containing condensate out of the concentrate air D and generation of a treated concentrate air D′.

A further concentrate air conduit 31ddd is connected to an outlet from the concentrate air condenser 86 and is also connected to an inlet 31e for introduction of treated concentrate air D′ into the first deconcentrator 81. The inlet 31e is shown by way of example as a simple connection site between the further concentrate air conduit 31ddd and the secondary flow channel 31a.

The secondary flow channel 31a is connected to the second branching apparatus 87b and an inlet 85i of the second deconcentrator 85. The waste air B is conducted through the secondary flow channel 31a to the adsorption region 85a of the second deconcentrator 85. After flowing through the adsorption region 85a of the second deconcentrator 85, the pollutant concentration of the waste air B (for example the NMP concentration) is lowered further to below 50 ppm, more preferably to below one ppm. Ideally, by way of example, the legal emission limits can already be observed at this point, such that the outlet 21 for discharge of waste air B into the environment may also already be disposed directly downstream of the second deconcentrator 85. It is optionally also possible for an activated carbon filter to be disposed between the outlet 21 and the second deconcentrator 85, in order, if appropriate, to further lower the pollutant concentration of the waste air B before removal into the environment 11. This may be the case, for example, if ageing effects set in in the deconcentrators and the actual deconcentration performance appears to be at variance from that originally intended.

As an alternative embodiment, several first condensers 2 with a respective main stream are operated in parallel, with merging of the waste air streams branched off from the respective main stream in the secondary flow channel 31a. The waste air B present in the secondary flow channel 31a is then conducted to the first deconcentrator 81.

FIG. 3a illustrates, by way of example, according to FIG. 3, a method S9 of cleaning the waste air by means of two deconcentration stages arranged in succession and two dirty gas cleaning methods S8b and S8c for desorption of a deconcentrator.

After a portion of the process air A, as in FIG. 2a, has been branched off from the main stream 5 in the respective method steps S44, S44a of the first and second branching operations, the waste air B is conducted to method steps S81 and S81b.

The method S9 of cleaning the waste air B has the following method steps:
S87a: Desorption air C′ from a portion of the waste air B is branched off downstream of the first deconcentration stage from the secondary stream 31 in a method step S87a. The proportion of the branched-off volume flow in this method step typically corresponds to 15% of the volume flow remaining after the branching-off.

As an alternative embodiment, several first condensers are operated in parallel with a respective main stream, where the waste air streams branched off from the respective main stream are merged into a secondary stream 31. Method step S81 is then executed on this merged secondary stream 31.
S81: The waste air B is cleaned in a first deconcentration stage by means of the deconcentrator 81, with lowering of the pollutant concentration from about 1000 ppm to about 50 ppm.
S85: The waste air B is cleaned in a second deconcentration stage by means of the deconcentrator 85, with further lowering of the pollutant concentration from about 40 ppm to below one ppm. It would optionally be possible additionally to filter the waste air B by means of an activated carbon filter after the second deconcentration stage.
S83: The waste air B cleaned after two deconcentration stages is released into the environment.

The dirty gas cleaning method S8b for desorbing the first deconcentrator has the following method steps:
S81b: A portion of the waste air B is conducted to a cooling region of the deconcentrator 81b, where the desorption air C′ is heated up to 200° C., especially up to 180° C., preferably up to about 100 to 140° C.
S87a: Desorption air C is branched off from a further portion of the waste air B upstream of the second deconcentration stage. The proportion of the branched-off volume flow in this method step typically corresponds to 15% of the volume flow of the waste air B which is deconcentrated in method step S81.
S84a: The branched-off portion of the waste air B is heated further by means of a desorption air heater to a desorption temperature of about 180 to 200° C. and conducted to the desorption region 81c as desorption air C.
S81c: After the heating, the desorption air C will desorb pollutant adsorbed in the adsorber 81d in a desorption step 81c as it flows through the desorption region 81c and remove it as concentrate air D.
S41a: The concentrate air D is conducted to the treatment by the first condensation step S41. Alternatively, it would be possible in this method step to divide the concentrate air D into two substreams, for example, before the substreams are each conducted to a separate condensation step.

The dirty gas cleaning method S8c for desorbing the second deconcentrator has the following method steps:
S85b: A portion of the waste air B is conducted to a cooling region of the deconcentrator 85b.
S87b: A portion of the waste air B is branched off for desorption of the deconcentrator. The proportion of the branched-off volume flow in this method step typically corresponds to 18% of the volume flow of waste air B which is deconcentrated in method step S85.
S84aa: The branched-off portion of the waste air B is heated up further by means of a desorption air heater to about 200° C. and conducted as desorption air to method step S85c.
S85c: After the heating, the desorption air C will desorb the pollutant adsorbed in the adsorber 85d in a desorption step 85c as it flows through the desorption region 85c and remove it as concentrate air D.
S86: The concentrate air D is conducted to a condensation step with a concentrate air condenser 86, with separation of a pollutant-containing condensate. A treated concentrate air D′ is generated after it has flowed through the concentrate air condenser 86.
S86a: The concentrate air D′ treated by the concentrate air condenser 86 is conducted to the treatment by the first deconcentration stage (S81) of the deconcentration step.

In addition, it should be pointed out finally that the deconcentration steps/stages (S80; S81, S85) or the deconcentrators (80; 81, 85) of examples disclosed herein are not limited to the wheel or disk concentrators shown in schematic form in FIGS. 2, 2a and 3, 3a, in particular zeolite wheels. In fact, it is also possible to provide or execute individual deconcentration stages/steps or deconcentrators in other configurations known to the person skilled in the art, for example designs in the form of carousel concentrators, without any significant effect on the implementation of examples disclosed here. Carousel concentrators are known, for example, from WO 2020/126551 A1 and U.S. Pat. No. 10,682,602 B2, the description content of which is hereby referred to explicitly with regard to possible alternative or supplementary designs of deconcentrators

1. A method of treating process gas from an industrial process having a main stream and a secondary stream, wherein at least a portion of the process gas is treated by the method, the method comprising:
separating, via a first condensation step, a first condensate out of the process gas;
branching off, via a first branching operation subsequent to the first condensation step (S41), at least a portion of the process gas from the main stream into the secondary stream as offgas; and
subjecting, via a first further treatment step subsequent to the first branching operation in the main stream, at least a portion of the process gas to further treatment after the first condensation step.

2. The method as claimed in claim 1, in which the first further treatment step includes a heating operation and/or a pressure-lowering operation, and/or feeding of gas outside the main stream, especially of air from an environment, and at least a portion of the process gas is treated, the method further including: recycling process gas downstream of the first condensation step into the industrial process.

3. The method as claimed in claim 1, in which at least a portion of the process gas, in a second branching operation that takes place after the first branching operation, especially after the first further treatment step, is branched off from the main stream and added to the offgas, where the relative saturation of the offgas branched off in the second branching operation is lower than the relative saturation of the offgas branched off in the first branching operation.

4. The method as claimed in claim 1, in which at least a portion of the offgas is treated by the following method steps:
a. a second condensation step subsequent to the first condensation step and in which a second condensate is separated out of the process gas,
b. a second further treatment step which takes place after the second condensation step and in which at least a portion of the offgas is subjected to further treatment after the second condensation step, comprising a heating operation and/or a pressure-lowering operation and/or a filtering operation;
c. a deconcentration step that takes place after the first condensation step, including at least one deconcentration stage for lowering the concentration of a pollutant; and/or
d. a filtering of the offgas that is subsequent to the condensation step.

5. The method as claimed in claim 1, wherein the following method steps are conducted for desorption of a deconcentrator:
a. a portion of the offgas is branched off before and/or after the portion of the offgas has been deconcentrated in a deconcentration stage;
b. the portion of the offgas branched off to provide a desorption gas,
c. a desorption step by means of the desorption gas, where the desorption gas flows through a desorption region of the deconcentrator and takes up at least one adsorbed pollutant,
d. the desorption gas, after flowing through the desorption region, is removed as concentrate gas, and
e. the concentrate gas is guided to a condensation step, especially to the first condensation step and/or to a further condensation step, and/or a deconcentration step.

6. The method as claimed in claim 1, wherein the following method steps are conducted:
a. a concentrate gas is produced after it has flowed through the desorption region of a deconcentrator,
b. the concentrate gas is treated in a condensation step and/or deconcentration step, wherein the treated concentrate gas
i. is guided to the first condensation step and/or
ii. is guided to a deconcentration step, especially to the first stage of the deconcentration step, and/or
iii. is divided into at least two substreams before at least one of the substreams of the treated concentrate gas is guided to a condensation step and/or to a deconcentration step.

7. The method as claimed in claim 5, in which method a deconcentration step includes at least two deconcentration stages arranged in succession in flow direction of the offgas, wherein each of the deconcentration stages has a deconcentrator, wherein a concentrate gas from a deconcentration stage downstream of at least one deconcentration stage is treated by at least one of the following method steps:
a. the concentrate gas is mixed with the concentrate gas from an upstream deconcentration stage; and/or
b. the concentrate gas is condensed in a condensation step and removed by a further concentrate gas conduit subsequent to the condensation step; and/or
c. the concentrate gas is conducted to a deconcentration stage, especially to the foremost deconcentration stage; and/or
d. the concentrate gas is guided to the first condensation step.

8. The method as claimed in claim 5, in which method a deconcentration step comprises at least two deconcentration stages arranged in succession in flow direction of the offgas, wherein each of the deconcentration stages has a deconcentrator, wherein a concentrate gas from a deconcentration stage upstream of a further deconcentration stage, in the case of three deconcentration stages or more, is arranged as the foremost deconcentration stage, comprising at least one of the following method steps:
a. the concentrate gas is mixed with the concentrate gas from a downstream deconcentration stage; and/or
b. the concentrate gas is condensed in a condensation step before being removed by a further concentrate gas conduit after the condensation step; and/or
c. the concentrate gas is guided to a deconcentration stage, especially to the foremost deconcentration stage; and/or
d. the concentrate gas is guided to the first condensation step.

9. An apparatus for treatment of process gas from an industrial process, especially for execution of a method as defined in claim 1, the apparatus comprising
an outlet for discharging process gas from an industrial process,
a heating element for heating the process gas, and
an inlet for introducing process gas into a first condenser, having:
a first cooling unit for cooling process gas,
a first branch site for branching off at least a proportion of process gas as offgas into a secondary stream channel, wherein the heating element is disposed downstream of the first branch site.

10. The apparatus as claimed in claim 9, further including a second branch site with which process gas is branched off into the secondary stream channel to lower the relative saturation of the offgas, wherein the first branch site is disposed downstream of the cooling unit and the second branch site is disposed downstream of the heating element.

11. The apparatus as claimed in claim 9, wherein the secondary stream channel, for introduction of at least a portion of the offgas, is connectable to:
a. an inlet, disposed downstream of the first condenser, for introduction into a second condenser, wherein a second condensate (17) is removed from the offgas;
b. an inlet, disposed downstream of the first condenser, for introduction into a deconcentrator for lowering the concentration of a pollutant; and/or
c. an inlet, disposed downstream of the first condenser, for introduction into a filter, especially into an activated carbon filter.

12. The apparatus as claimed in any of claims 10, especially for performance of a method of desorption of a deconcentrator, the apparatus further including:
a branching apparatus for removing a portion of the offgas, wherein the branched-off portion of the offgas is guided to a heating unit in which desorption gas for desorption of the deconcentrator is generated.

13. The apparatus as claimed in claim 10, further including:
a deconcentrator having at least one adsorption region and one desorption region, and
a concentrate gas conduit for guiding concentrate gas out of the desorption region to an inlet for introduction of concentration gas into the first condenser and/or into a concentrate gas condenser and/or into an adsorption region of a deconcentrator.

14. The apparatus as claimed in claim 10, further including at least two deconcentrators arranged in succession based on the flow direction of the offgas, each of which has at least one adsorption region and one desorption region, a second concentrate gas conduit for removing concentrate gas from the desorption region of a downstream deconcentrator, wherein the second concentrate gas conduit, for introduction of the concentrate gas, is connectable to:
a. an inlet for introduction into an adsorption region (81a, 85a) of a deconcentrator;
b. a first concentrate gas conduit of an upstream deconcentrator for mixing with the concentrate gas therefrom;
c. the inlet for introduction into the first condenser and/or
d. an inlet for introduction into a concentrate gas condenser.

15. The apparatus as claimed in claim 13, wherein a further concentrate gas conduit for introduction of a concentrate gas treated in a condenser and/or deconcentrator by an inlet for introduction to the first condensation step and/or an inlet for introduction into a deconcentrator, and/or a divider, where the treated concentrate gas is divided into at least two substreams before at least one of the substreams of the treated concentrate gas is guided by an inlet for introduction into a condenser and/or into a deconcentrator.

16. The apparatus as claimed in claim 9, further including:
at least two deconcentrators arranged in succession based on the flow direction of the offgas, each of which has at least one adsorption region and one desorption region,
a first concentrate gas conduit for removal of concentrate gas from the desorption region of an upstream deconcentrator, in the case of at least three deconcentrators the foremost deconcentrator, wherein the first concentrate gas conduit, for introduction of the concentrate gas, is connectable to:
a. an inlet for introduction into the adsorption region of a deconcentrator;
b. an inlet for introduction into a condensate gas condenser (86);
c. the second concentrate gas conduit of a downstream deconcentrator for mixing with the concentrate gas therefrom; and/or
d. the inlet for introduction into the first condenser.

17. The use of the method as claimed in claim 1, for treatment of a process fluid conducted in circulation, especially circulated air from a dryer for treatment of process air from a dryer, especially from the process air from a manufacturing plant for production of electrodes of a battery.

18. The use of the apparatus as claimed in claim 9 for treatment of a process fluid conducted in circulation, especially circulated air from a dryer for treatment of process airfrom a dryer, especially from the process air from a manufacturing plant for production of electrodes of a battery.
